(19) United States
(12) Patent Application Publication
(10) Pub. No.: US 2014/0006012 A1
(43) Pub. Date: Jan. 2, 2014

(54) Learning-Based Processing of Natural Language Questions

(71) Applicants: Ming Zhou, Beijing (CN); Furu Wei, Beijing (CN); Xiaohua Liu, Beijing (CN); Hong Sun, Beijing (CN); Yajuan Duan, Beijing (CN); Chengjie Sun, Beijing (CN); Heung-Yeung Shum, Medina, WA (US)

(72) Inventors: Ming Zhou, Beijing (CN); Furu Wei, Beijing (CN); Xiaohua Liu, Beijing (CN); Hong Sun, Beijing (CN); Yajuan Duan, Beijing (CN); Chengjie Sun, Beijing (CN); Heung-Yeung Shum, Medina, WA (US)

(73) Assignee: MICROSOFT CORPORATION, Redmond, WA (US)

(21) Appl. No.: 13/539,674

(22) Filed: Jul. 2, 2012

(51) Int. Cl. G06F 17/27

(52) U.S. Cl. 704/9

(57) ABSTRACT

Techniques described enable answering a natural language question using machine learning-based methods to gather and analyze evidence from web searches. A received natural language question is analyzed to extract query units and to determine a question type, answer type, and/or lexical answer type using rules-based heuristics and/or machine learning trained classifiers. Query generation templates are employed to generate a plurality of ranked queries to be used to gather evidence to determine the answer to the natural language question. Candidate answers are extracted from the results based on the answer type and/or lexical answer type, and ranked using a ranker previously trained offline. Confidence levels are calculated for the candidate answers and top answer(s) may be provided to the user if the confidence levels of the top answer(s) surpass a threshold.

### BACKGROUND

Online search engines provide a powerful means for users to locate content on the web. Perhaps because search engines are software programs, they developed to more efficiently process queries entered in a form such as a Boolean query that mirrors the formality of a programming language. However, many users may prefer to enter queries in a natural language form, similar to how they might normally communicate in everyday life. For example, a user searching the web to learn the capital city of Bulgaria may prefer to enter “What is the capital of Bulgaria?” instead of “capital AND Bulgaria.” Because many search engines have been optimized to accept user queries in the form of a formal query, they may be less able to efficiently and accurately respond to natural language queries.

Previous solutions tend to rely on a curated knowledge base of data to answer natural language queries. This approach is exemplified by the Watson question answering computing system created by IBM®, which famously appeared on and won the Jeopardy!® game show in the United States. Because Watson and similar solutions rely on a knowledge base, the range of questions they can answer may be limited to the scope of the curated data in the knowledge base. Further, such a knowledge base may be expensive and time consuming to update with new data.

### SUMMARY

Techniques are described for answering a natural language question entered by a user as a search query, using machine learning-based methods to gather and analyze evidence from web searches. In some examples, on receiving a natural language question entered by a user, an analysis is performed to determine a question type, answer type, and/or lexical answer type (LAT) for the question. This analysis may employ a rules-based heuristic and/or a classifier trained offline using machine learning. One or more query units may also be extracted from the natural language question using chunking, sentence boundary detection, sentence pattern detection, parsing, named entity detection, part-of-speech tagging, tokenization, or other tools.

In some implementations, the extracted query units, answer type, question type, and/or LAT may then be applied to one or more query generation templates to generate a plurality of queries to be used to gather evidence to determine the answer to the natural language question. The queries may then be ranked using a ranker that is trained offline using machine learning, and the top N ranked queries may be sent to a search engine. Results (e.g., addresses and/or snippets of web documents) may then be filtered and/or ranked using another machine learning trained ranker, and candidate answers are extracted from the results based on the answer type and/or LAT. Candidate answers may be ranked using a ranker that is trained offline using machine learning, and the top answers may be provided to the user. A confidence level may also be determined for the candidate answers, and a top answer may be provided if its confidence level exceeds a threshold confidence.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 depicts an example use case for answering a natural language question, according to embodiments.

FIG. 2 is a diagram depicting an example environment in which embodiments may operate.

FIG. 3 is a diagram depicting an example computing system, in accordance with embodiments.

FIG. 4 depicts a flow diagram of an illustrative process for answering a natural language question, according to embodiments.

FIG. 5 depicts a flow diagram of an illustrative process for analyzing a natural language question to determine question type, answer type, LAT, and/or query units, according to embodiments.

FIG. 6 depicts a flow diagram of an illustrative process for determining a plurality of search queries to gather evidence for answering a natural language question, according to embodiments.

FIG. 7 depicts a flow diagram of an illustrative process for analyzing search results as evidence for answering a natural language question, according to embodiments.

FIG. 8 depicts a flow diagram of an illustrative process for extracting possible answers from the search results evidence, according to embodiments.

### DETAILED DESCRIPTION

### Overview

Embodiments described herein provide techniques for answering a natural language question entered by a user as a search query. In some embodiments, a natural language question is received (e.g., by a search engine) as a search query from a user looking for an answer to the question. As described herein, a natural language question includes a sequence of characters that at least in part may employ a grammar and/or syntax that characterizes normal, everyday speech. For example, a user may ask the question “What is the capital of Bulgaria?” or “When was the Magna Carta signed?” Although some examples given herein describe a natural language question that includes particular question forms (e.g., who, what, where, when, why, how, etc.), embodiments are not so limited and may support natural language questions in any form.

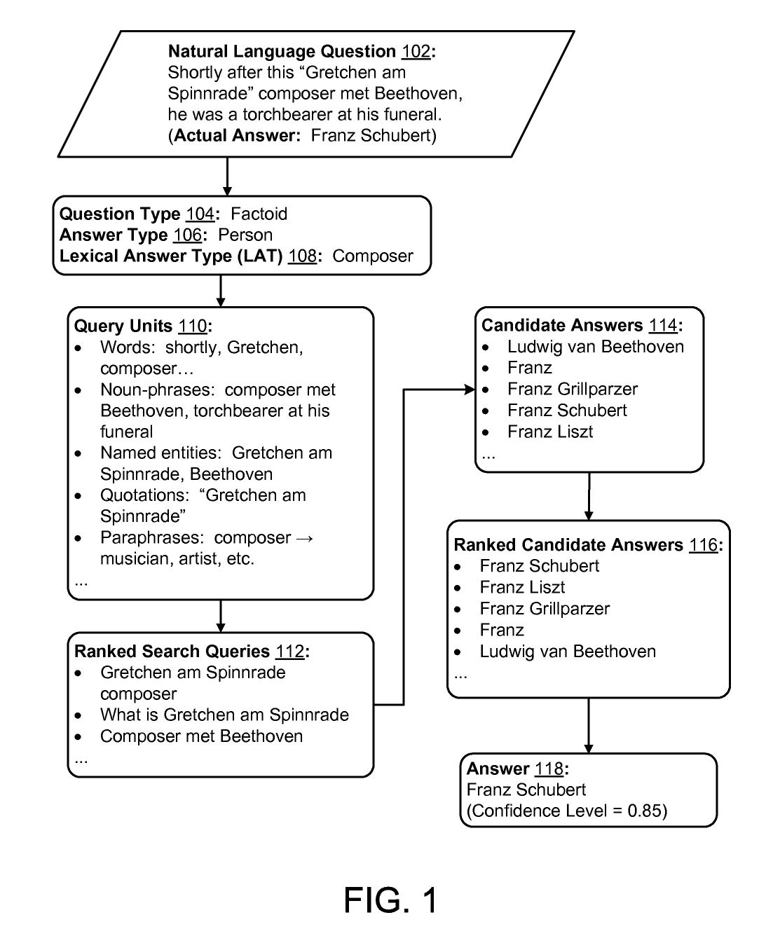

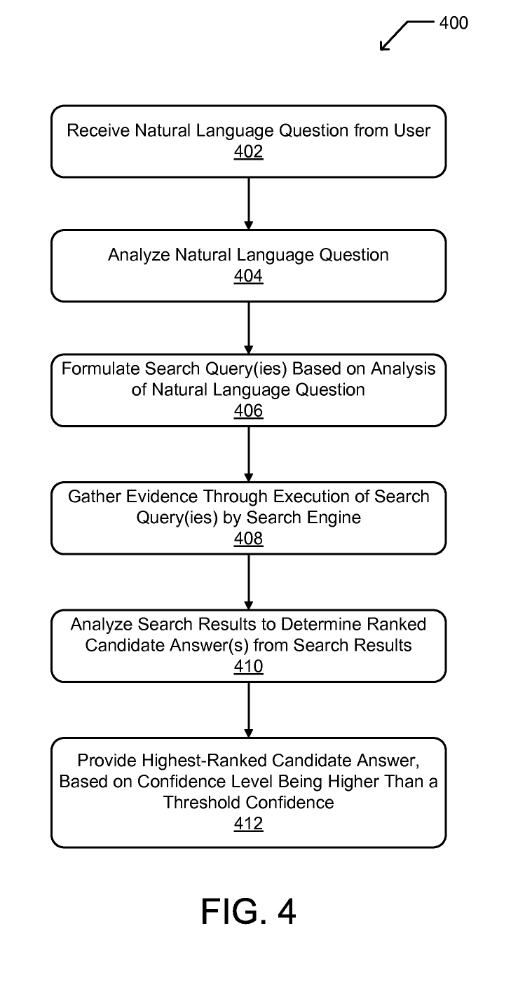

To identify at least one answer to the natural question, embodiments employ four phases: Question Understanding, Query Formulation, Evidence Gathering, and Answer Extraction/Ranking. Each of the four phases is described in further detail with reference to FIGS. 4-8. The remainder of the overview section describes these four phases briefly with reference to an example case illustrated in FIG. 1. This example case begins with receiving the natural language question 102: “Shortly after this ‘Gretchen am Spinnrade’ composer met Beethoven, he was a torchbearer at his funeral.” Embodiments employ web search evidence gathering and analysis (at least partly machine learning-based) to attempt to ascertain an answer. The actual answer in this example is “Franz Schubert.”

In some embodiments, Question Understanding includes analysis of the natural language question to predict a question type and an answer type. Question type may include a factoid type (e.g., “What is the capital of Bulgaria?”), a definition type (e.g., “What does ‘ambidextrous’ mean?”), a puzzle type (e.g., “What words can I spell with the letters BYONGEO”), a mathematics type (e.g., “What are the lowest ten happy numbers?”), or any other type of question. Answer types may include a person, a location, a time/date, a quantity, an event, an organism (e.g., animal, plant, etc.), an object, a concept, or any other answer type. In some embodiments, a lexical answer type (LAT) may also be predicted. The LAT may be more specific and/or may be a subset of the answer type. For example, a question with answer type “person” may have a LAT of “composer.” Prediction of question type, answer type, and/or LAT may use a rules-based heuristic approach, a classifier trained offline (e.g., prior to receiving the natural language question online) using machine learning, or a combination of these two approaches. In the example of FIG. 1, the natural language question 102 has a question type 104 of factoid type, an answer type 106 of person, and a LAT 108 of composer.

Question Understanding may also include the extraction of query units from the natural language question. Query units may include one or more of the following: words, base noun-phrases, sentences, named entities, quotations, paraphrases (e.g., reformulations based on synonyms, hypernyms, and the like), and facts. Query units may be extracted using a grammar-based analysis of the natural language question, including one or more of the following: chunking, sentence boundary detection, sentence pattern detection, parsing, named entity detection, part-of-speech tagging, and tokenization. In the example shown in FIG. 1, natural language question 102 includes query units 110 such as words (e.g., “shortly,” “Gretchen,” “composer,” etc.), noun-phrases (e.g., “composer met Beethoven,” “torchbearer at his funeral,” etc.), named entities (e.g., “Gretchen am Spinnrade,” “Beethoven,” etc.), quotations (e.g., “‘Gretchen am Spinnrade’”), and paraphrases (e.g., rewording composer to “musician,” “artist,” and so forth).

In some embodiments, the second phase is Query Formulation. In this phase, the information gained from the Question Understanding phase may be used to generate one or more search queries for gathering evidence to determine an answer to the natural language question. In some embodiments, the extracted query units as well as the question type, answer type, and/or LAT are applied to one or more query generation templates to generate a set of candidate queries. The candidate queries may be ranked using a ranker trained offline using an unsupervised or supervised machine learning technique such as support vector machine (SVM). In some embodiments, a predefined number N (e.g., 25) of the top ranked queries are sent to be executed by one or more web search engines such as Microsoft®Bing®. In the example shown in FIG. 1, the top three ranked search queries 112 are determined: “Gretchen am Spinnrade composer,” “What is Gretchen am Spinnrade,” and “Composer met Beethoven.”

In some embodiments, the third phase is Evidence Gathering, in which the top N ranked search queries are executed by search engine(s) and the search results are analyzed. In some embodiments, the top N results of each search query (e.g., as ranked by the search engine that executed the search query) are merged with one another to create a merged list of search results. In some embodiments, search results may include an address for a result web page, such as a Uniform Resource Locator (URL), Uniform Resource Identifier (URI), Internet Protocol (IP) address, or other identifier, and/or a snippet of content from the result web page. The merged search results may be filtered to remove duplicate results and/or noise results.

In a fourth phrase Answer Extraction/Ranking, candidate answers may be extracted from the search results. In some embodiments, candidate answer extraction includes dictionary-based entity recognition of those named entities in the search result pages that have a type that matches the answer type and/or LAT determined in the Question Understanding phase. In some embodiments, the extracted named entities are normalized to expand contractions, correct spelling errors in the search results, expand proper names (e.g., Bill to William), and so forth. In the example of FIG. 1, extracted candidate answers 114 include Ludwig van Beethoven, Franz, Franz Grillparzer, Franz Schubert, and Franz Liszt.

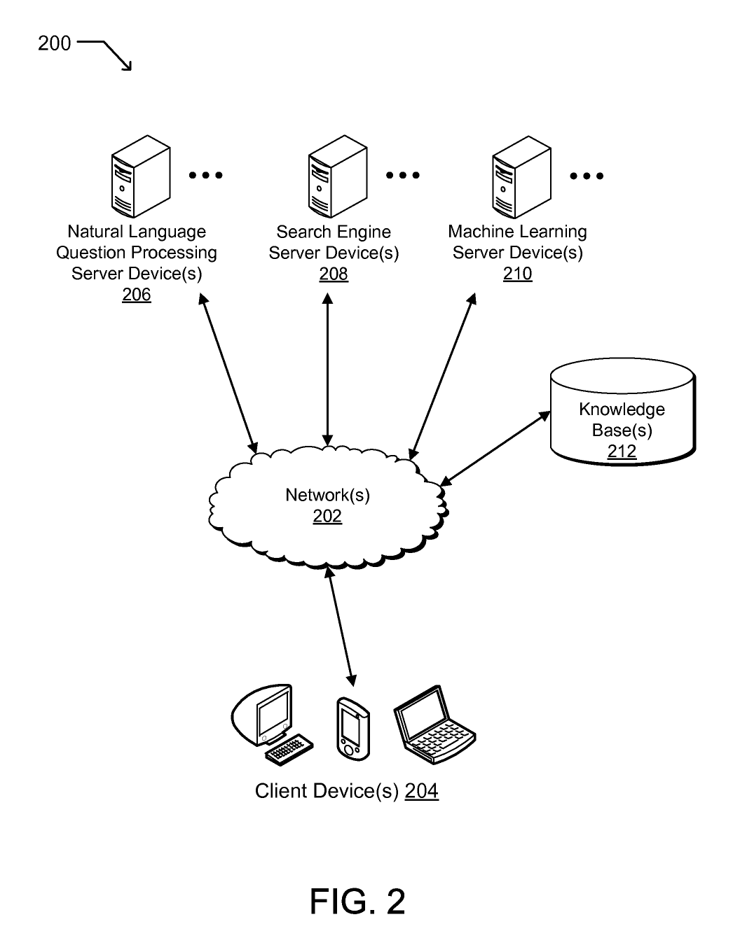

The candidate answers may then be ranked by applying a set of features determined for each candidate answer to a ranker trained offline using a machine learning technique (e.g., SVM). In the example of FIG. 1, the ranked candidate answers 116 are Franz Schubert, Franz Liszt, Franz Grillparzer, Franz, and Ludwig van Beethoven. In some embodiments, a confidence level may be determined for one or more of the top ranked candidate answers. The confidence level may be normalized from zero to one, and, in some embodiments, the top-ranked candidate answer is provided as the answer to the user's question when the top-ranked candidate answer has a confidence level that exceeds a predetermined threshold confidence level. In the example of FIG. 1, the answer 118 is Franz Schubert with a confidence level of 0.85. Embodiments are described in further detail below with references to FIGS. 2-8.

### Illustrative Environment

FIG. 2 shows an example environment 200 in which embodiments may operate. As shown, the computing devices of environment 200 communicate with one another via one or more networks 202 that may include any type of networks that enable such communication. For example, networks 202 may include public networks such as the Internet, private networks such as an institutional and/or personal intranet, or some combination of private and public networks. Networks 202 may also include any type of wired and/or wireless network, including but not limited to local area networks (LANs), wide area networks (WAN5), Wi-Fi, WiMax, and mobile communications networks (e.g. 3G, 4G, and so forth). Networks 202 may utilize communications protocols, including packet-based and/or datagram-based protocols such as IP, transmission control protocol (TCP), user datagram protocol (UDP), or other types of protocols. Moreover, networks 202 may also include any number of devices that facilitate network communications and/or form a hardware basis for the networks, such as switches, routers, gateways, access points, firewalls, base stations, repeaters, backbone devices, and the like.

Environment 200 further includes one or more client computing devices such as client device(s) 204. In some embodiments, client device(s) 204 are associated with one or more end users who may provide natural language questions to a web search engine or other application. Client device(s) 204 may include any type of computing device that a user may employ to send and receive information over networks 202. For example, client device(s) 204 may include, but are not limited to, desktop computers, laptop computers, tablet computers, e-Book readers, wearable computers, media players, automotive computers, mobile computing devices, smart phones, personal data assistants (PDAs), game consoles, mobile gaming devices, set-top boxes, and the like. Client device(s) 204 may include one or more applications, programs, or software components (e.g., a web browser) to enable a user to browse to an online search engine or other networked application and enter a natural language question to be answered through the embodiments described herein.

As further shown FIG. 2, environment 200 may include one or more server computing devices such as natural language question processing server device(s) 206, search engine server device(s) 208, and machine learning server device(s) 210. In some embodiments, one or more of these server computing devices is managed by, operated by, and/or generally associated with an individual, business, or other entity that provides network services for answering natural language questions according to the embodiments described herein. These server computing devices may be virtually any type of networked computing device or cluster of networked computing devices. Although these three types of servers are depicted separately in FIG. 2, embodiments are not limited in this way. In some embodiments, the functionality of natural language question processing server device(s) 206, search engine server device(s) 208, and/or machine learning server device(s) 210 may be combined on one or more servers or clusters of servers in any combination that may be chosen to optimize performance, for efficiently use physical space, for business reasons, for usability reasons, or other reasons.

In some embodiments, natural language question processing server device(s) 206 provide services for receiving, analyzing, and/or answering natural language questions received from users of client device(s) 204. These services are described further herein with regard to FIGS. 4-8.

In some embodiments, search engine server device(s) 208 provide services (e.g., a search engine software application and user interface) for performing online web searches. As such, these servers may receive web search queries and provide results in the form of an address or identifier (e.g., URL, URI, IP address, and the like) of a web page that satisfies the search query, and/or at least a portion of content (e.g., a snippet) from the resulting web page. Search engine server device(s) 208 may also rank search results in order of relevancy or predicted user interest. In some embodiments, natural language question processing server device(s) 206 may employ one or more search engines hosted by search engine server device(s) 208 to gather evidence for answering a natural language question, as described further herein.

In some embodiments, machine learning server device(s) 210 provide services for training classifier(s), ranker(s), and/or other components to classifying and/or ranking as described herein. These services may include unsupervised and/or supervised machine learning techniques such as SVM.

As shown in FIG. 2, environment 200 may also include one or more knowledge base(s) 212. These knowledge base(s) may be used to supplement the web search-based techniques described herein, and may include general-interest knowledge bases (e.g., Wikipedia®, DBPedia®, Freebase®) or more specific knowledge bases curated to cover specific topics of interest.

### Illustrative Computing System Architecture

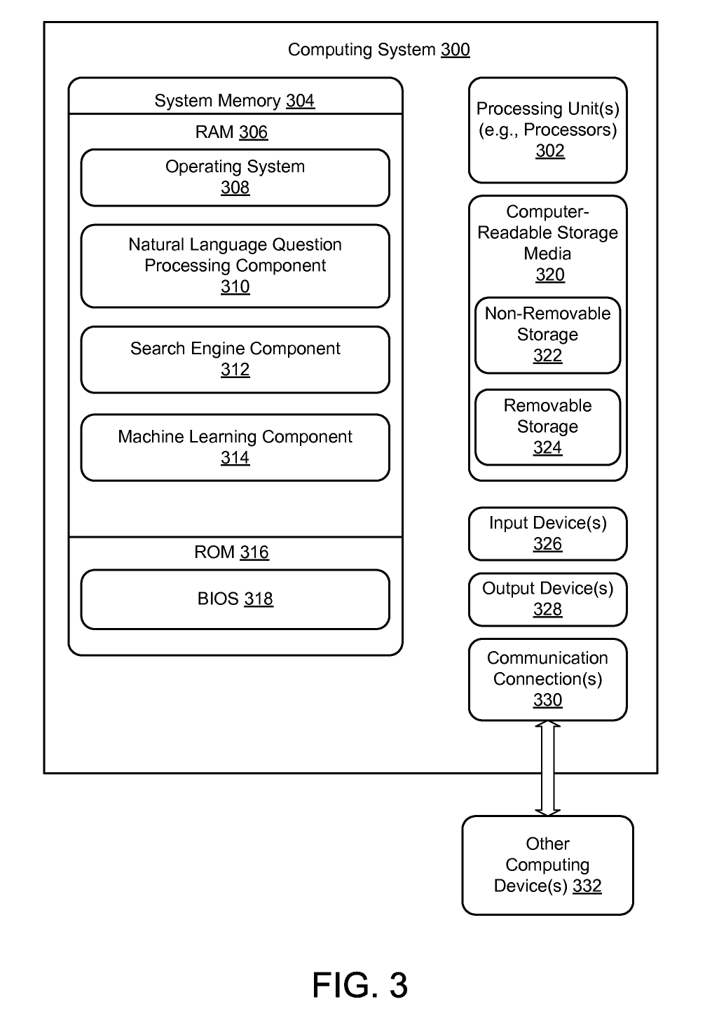

FIG. 3 depicts an example computing system 300 in which embodiments may operate. In some embodiments, computing system 300 is an example of client device(s) 204, natural language question processing server device(s) 206, search engine server device(s) 208, and/or machine learning server device(s) 210 depicted in FIG. 2. Computing system 300 includes processing unit(s) 302. Processing unit(s) 302 may encompass multiple processing units, and may be implemented as hardware, software, or some combination thereof. Processing unit(s) 302 may include one or more processors. As used herein, processor includes a hardware component. Moreover, processing unit(s) 302 may include computer-executable, processor-executable, and/or machine-executable instructions written in any suitable programming language to perform various functions described herein.

Computing system 300 further includes a system memory 304, which may include volatile memory such as random access memory (RAM) 306, static random access memory (SRAM), dynamic random access memory (DRAM), and the like. RAM 306 includes one or more executing operating systems (OS) 308, and one or more executing processes including components, programs, or applications that are loadable and executable by processing unit 302. Such processes may include a natural language question process component 310 to perform actions for receiving, analyzing, gathering evidence pertaining to, and/or answering a natural language question provided by a user. These functions are described further herein with regard to FIGS. 4-8. RAM 306 may also include a search engine component 312 for performing web searches based on web queries, and a machine learning component 314 to train classifiers or other entities using supervised or unsupervised machine learning methods.

System memory 304 may further include non-volatile memory such as read only memory (ROM) 316, flash memory, and the like. As shown, ROM 316 may include a Basic Input/Output System (BIOS) 318 used to boot computing system 300. Though not shown, system memory 304 may further store program or component data that is generated and/or utilized by OS 308 or any of the components, programs, or applications executing in system memory 304. System memory 304 may also include cache memory.

As shown in FIG. 3, computing system 300 may also include computer-readable storage media 320 such as non-removable storage 322 (e.g., a hard drive) and/or removable storage 324, including but not limited to magnetic disk storage, optical disk storage, tape storage, and the like. Disk drives and associated computer-readable media may provide non-volatile storage of computer readable instructions, data structures, program modules, and other data for operation of computing system 300.

In general, computer-readable media includes computer-readable storage media and communications media.

Computer-readable storage media is tangible media that includes volatile and non-volatile, removable and non-removable media implemented in any method or technology for storage of information such as computer-readable instructions, data structure, program modules, and other data. Computer storage media includes, but is not limited to, RAM, ROM, erasable programmable read-only memory (EEPROM), SRAM, DRAM, flash memory or other memory technology, compact disc read-only memory (CD-ROM), digital versatile disks (DVDs) or other optical storage, magnetic cassettes, magnetic tape, magnetic disk storage or other magnetic storage devices, or any other non-transmission medium that can be used to store information for access by a computing device.

In contrast, communication media is non-tangible and may embody computer readable instructions, data structures, program modules, or other data in a modulated data signal, such as a carrier wave or other transmission mechanism. As defined herein, computer-readable storage media does not include communication media.

Computing system 300 may also include input device(s) 326, including but not limited to a keyboard, a mouse, a pen, a game controller, a voice input device for speech recognition, a touch screen, a touch input device, a gesture input device, a motion- or object-based recognition input device, a biometric information input device, and the like. Computing system 300 may further include output device(s) 328 including but not limited to a display, a printer, audio speakers, a haptic output, and the like. Computing system 300 may further include communications connection(s) 330 that allow computing system 300 to communicate with other computing device(s) 332 including client devices, server devices, databases, and/or other networked devices available over one or more communication networks.

### Example Operations

FIGS. 4-8 depict flowcharts showing example processes in accordance with various embodiments. The operations of these processes are illustrated in individual blocks and summarized with reference to those blocks. The processes are illustrated as logical flow graphs, each operation of which may represent one or more operations that can be implemented in hardware, software, or a combination thereof. In the context of software, the operations represent computer-executable instructions stored on one or more computer storage media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations may be combined in any order, subdivided into multiple sub-operations, and/or executed in parallel to implement the described processes. In some embodiments, the processes illustrated in FIGS. 4-8 are executed by one or more of natural language question processing server device(s) 206 and/or natural language question processing component 310.

FIG. 4 depicts a flow diagram of an illustrative process 400 for answering a natural language question, according to embodiments. This process may follow the four phases described above: Question Understanding, Query Formulation, Evidence Gathering, and Answer Extraction/Ranking. At 402, a natural language question is received. In some embodiments, the question may be received during an online communication session from a user such as a user of client device(s) 204, and may be provided by the user through a user interface of a search web site or other network application. In some embodiments, a category may also be received. For example (e.g., as in the Jeopardy!® game), information may be received indicating that the natural language question is in a broad category such as Geography, History, Science, Entertainment, and the like, or a more narrow category such as Australian Geography, History of the Byzantine Empire, Science of Carbohydrate Metabolism, and the like.

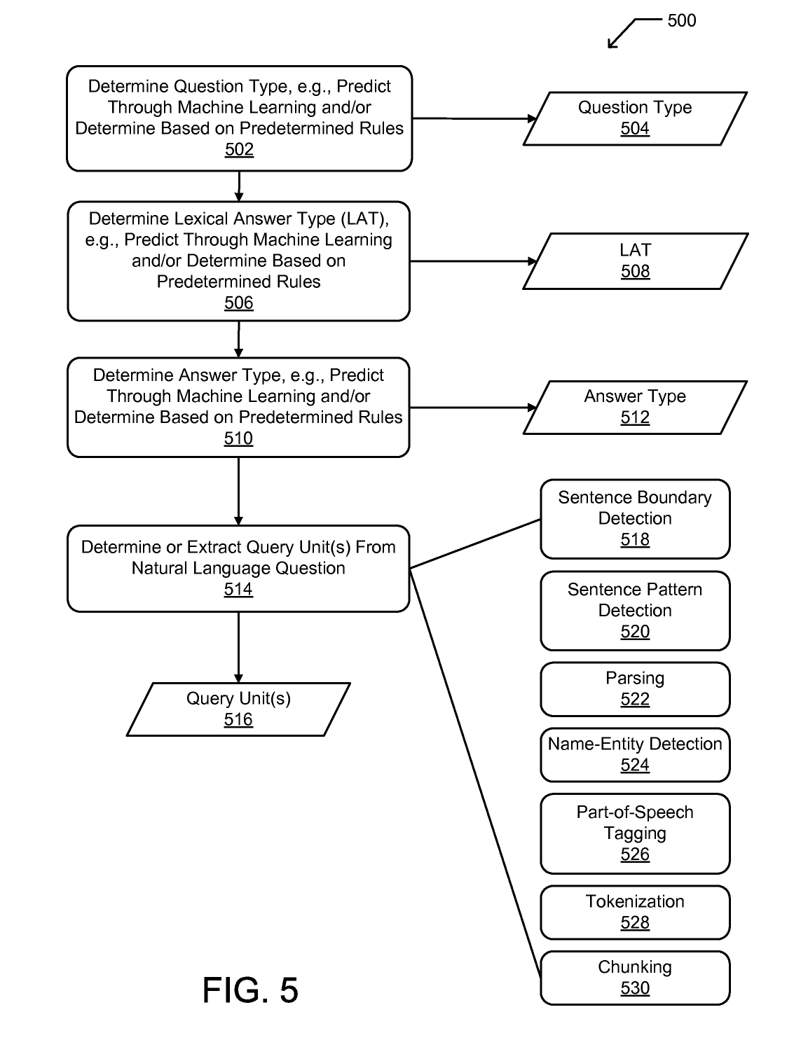

At 404, the natural language question and/or category is analyzed to predict or determine a question type and an answer type associated with the natural language question. In some embodiments, a LAT is also predicted for the question. One or more query units may also be extracted from the natural language question. These tasks are part of the Question Understanding phase, and are described in further detail with regard to FIG. 5.

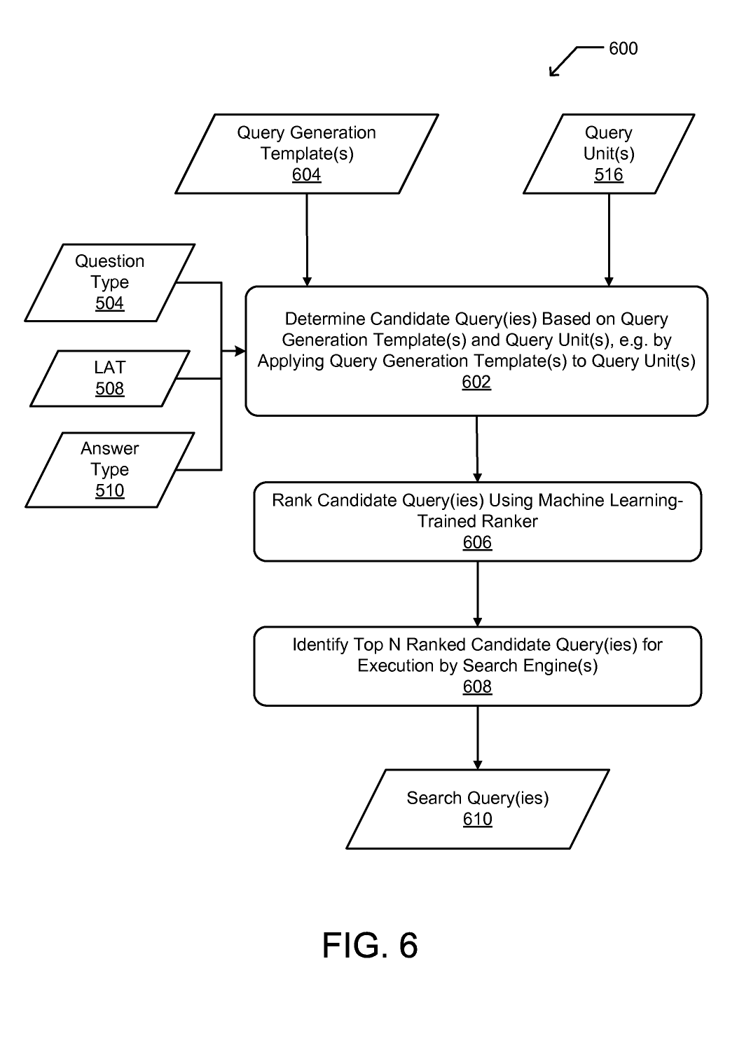

At 406, one or more search queries are formulated based on the analysis of the natural language question at 404. In some embodiments, this formulation includes applying the query units, question type, answer type, and/or LAT to one or more query generation templates. These tasks are part of the Query Formulation phase and are described further with regard to FIG. 6.

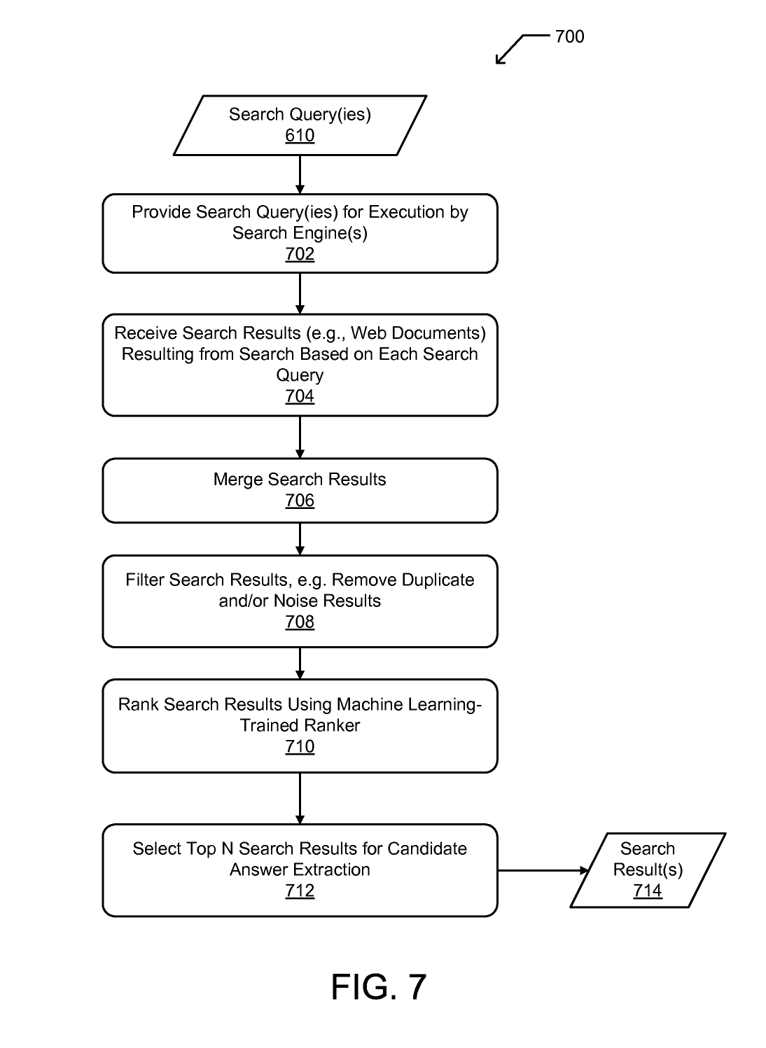

At 408, evidence is gathered through execution of the one or more search queries by at least one search engine. This Evidence Gathering phase is described further with regard to FIG. 7.

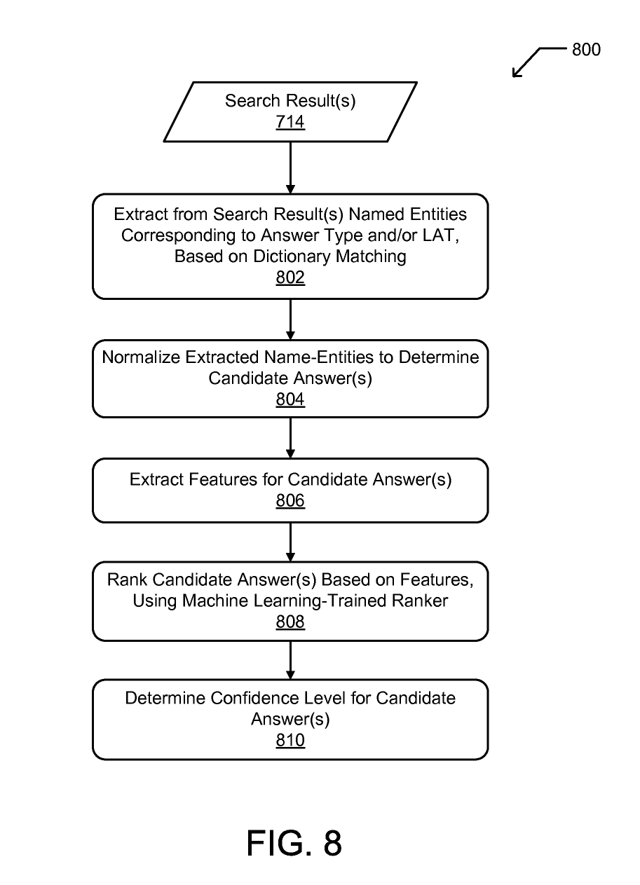

At 410, the search results resulting from execution of the one or more search queries are analyzed to extract or otherwise determine and rank one or more candidate answers from the search results. This Answer Extraction and Ranking phase is described further with regard to FIG. 8.

At 412, one or more candidate answers are provided to the user. In some embodiments, a certain predetermined number of the top ranked candidate answers are provided to the user. In some embodiments, a confidence level may also be provided alongside each candidate answer to provide a measure of confidence that the system has that the candidate answer may be accurate. In some embodiments, a highest-ranked candidate answer is provided to the user as the answer to the natural language question, based on the confidence level for that highest-ranked candidate answer being higher than a predetermined threshold confidence level. Further, in some embodiments if there is no candidate answer with a confidence level higher than the threshold confidence level, the user may be provided with a message or other indication that no candidate answer achieved the minimum confidence level.

Mathematically, process 400 may be described as follows in Formula 1:

$${argmax}_{h ∈ H \\} \frac{P ( h \vert Q )}{{\sum }_{{h}^{′} ∈ H}^{ } P ( {h}^{′} \vert Q )} ∝ P ( h \vert Q ) ≡ P ( h \vert Q , S , K ) ∝ {\sum }_{t ∈ T}^{ } P ( t \vert Q ) \times [ {\sum }_{q}^{ } P ( q \vert Q , t , K ) \times P ( r \vert q , S ) ] \times P ( {R}^{′} \vert R ) \times P ( h \vert t , {R}^{′} , K ) \times [ P ( h \vert e ) \times P ( e \vert h , t , {Q}_{P} , {R}^{′} , K ) ] \qquad ( Formula 1 )$$

where Q denotes the input natural language question, [symbol] denotes the hypothesis space of candidate answers, and h denotes a candidate answer. Embodiments aim to find the hypothesis (e.g., answer) h which maximizes the probability P(h|Q).

P(h|Q) may be further induced to P(h|Q, S, K), where S denotes the search engine and K denotes the knowledge base (in embodiments that use an adjunct knowledge base). The formula may be further decomposed into the following parts:
P(t|Q) where t denotes an answer type (T denotes the answer type collection), i.e. the probability of question Q with t as the answer type;
P(q|Q, t, K) where q denotes a search query generated from Q, together with t as the answer type and knowledge base K, i.e. the probability of generate q as the one of the search queries from Q;
P(r|q, S), where r denotes the search results returned by searching S with q as the search query;
P(R′|R) where R denotes the merged search results from different search query, and R′denotes the re-ranked top N search results;
P(h|t, R′, K): the probability of extracting h as the candidate answer from search results R′;
P(e|h, t, Q_{P}, R′, K) where e denotes the ranking feature for candidate answer h, Qₚ is the question profile which includes LAT and Answer Type; and/or
P(h|e), i.e. the probability of ranking result h given feature set e.

### Example Operations for Question Understanding

FIG. 5 depicts a flow diagram of an illustrative process 500 for analyzing a natural language question to determine question type, answer type, LAT, and/or query units, according to embodiments. At 502, a question type 504 is determined based on an analysis of the natural language question. In embodiments where a question category is also received with the natural language question, the category may also be analyzed to determine a question type. Question type 504 may be a factoid type, a definition type, a puzzle type, a mathematics type, or any other type of question. In some embodiments, a question type classifier is applied to the natural language question to predict its question type. This classifier may be trained offline using multiple features in accordance with an unsupervised or supervised machine learning technique such as SVM. In some embodiments the features used to trained the classifier may include, but are not limited to, one or more of the following:
Whether the natural language questions corresponds to or matches one or more predefined regular expressions;
Whether the natural language question includes a pattern such as “from <language> for <phrase>, <focus>”, “<focus> is <language> for <phrase>”, “is the word for”, and/or “means”, where focus may indicate a determined key term or phrase that is the focus of the natural language question;
Whether the category text contains recurring category types;
Whether the question is a phrase with no focus;
Whether the category specifies a language to translate to or from;
Whether the question text includes a single entity or a short list of entities; and/or
Whether the focus is the object of a “do” verb.
   In some embodiments, a heuristic approach may be used to determine the question type based on a set of predetermined rules.

At 506, a lexical answer type (LAT) 508 may be determined based on an analysis of the natural language question. In some embodiments, the LAT 508 is a word or phrase which identifies a category for the answer to the natural language question. In some cases, the LAT may be a word or phrase found in the natural language question itself. In some embodiments, a heuristic, rules-based approach is used to determine the LAT. For example, a binary linear decision tree model may be employed, incorporating various rules, and the LAT may be determined by traversing the decision tree for each noun-phrase (NP) in the natural language question. Rules may include one or more of the following:
If [this NP] question is 1, then [NP-head is LAT];
If [these NP] question is 1, then [NP-head is LAT];
If [it be NP] question is 1, then [NP-head is LAT];
If [this NP] question is 0, [third-person pronoun] question is 1, then [third-person pronoun is LAT];
If [this NP] question is 0, [Noun3 paraphrase] topic is 1, then [Noun3 is LAT]; and/or
If [this NP1] question is 0, [NP2] topic is 1, then [NP2-head is LAT].

As an example application of the above rules, the following natural language question may be received: “He wrote his ‘Letter from Birmingham Jail’ from the city jail in Birmingham, Ala. in 1963.” This question may have been received with a category of “Prisoners' Sentences.” Determination of the LAT may follow the rules in the decision tree above:
First, does the natural language question contain the word “this”? No;
Second, does the natural language question contain the word “these”? No;
Third, does the natural language question contain an “it be” structure? No;
Fourth, does the natural language question include any pronoun words? Yes, it includes “he”; and
Finally, based at least on the above determinations a LAT of “he” may be determined for the natural language question.

In some embodiments, the LAT is predicted through a machine learning process by applying a classifier trained offline to one or more features of the natural language question. In embodiments, this machine learning-based approach for determining the LAT may be used instead of or in combination with the heuristic, rules-based approach described above.

At 510, an answer type 512 is determined based on an analysis of the natural language question. Answer type 512 may be a person, a location, a time/date, a quantity, an event, an organism (e.g., animal, plant, etc.), an object, a concept, or any other answer type. In some embodiments, a machine learning-trained classifier is used to predict the answer type based on a plurality of features of the natural language question. In some embodiments, a log-linear classification model may be employed. This model may be expressed mathematically as in Formula 2:

t=argmaxₜ_{ᵢ} log P(tⱼ)+Σⱼ₌₁^{k} log P(xⱼ|tᵢ), (Formula 2)

where t denotes the determined answer type, xⱼ denotes the features for jΣ[1, K], and tᵢ denotes the possible answer types for iε[1, N]. Features may include, but are not limited to, the following:
LAT;
LAT context, the nearest N number of words before and after the LAT in the natural language question (e.g., N=3);
Title tag, whether the LAT is contained in a title dictionary (e.g., as in an external knowledge base 212, or commercial available online dictionary such as WordNet®);
Synonym words of the LAT, e.g. as determined through a dictionary;
Hypernym words of the LAT, e.g. as determined through a dictionary; and/or
Specific unigram, e.g. whether the question includes particular words such as where, who, what, etc.

In some embodiments, prediction of the answer type may be performed based on application of a plurality of rules to the natural language question, either separate from or in combination with the machine learning-based technique described above.

At 514, one or more query units 516 are extracted from the natural language question, based on grammar-based and/or syntax based analysis of the question. Query units may include one or more of the following: words, base noun-phrases, sentences, named entities, quotations, paraphrases (e.g., reformulations based on synonyms, hypernyms, and the like), dependency relationships, time and number units, and facts. Further, some embodiments may employ at least one knowledge base as an adjunct to the search query-based methods described herein. In such cases, the extracted query units may also include attributes of the natural language question found in the at least one knowledge base. Extraction of query units may include one or more of the following: sentence boundary detection 518, sentence pattern detection 520, parsing 522, named entity detection 524, part-of-speech tagging 526, tokenization 528, and chunking 530.

### Example Operations for Query Formulation

FIG. 6 depicts a flow diagram of an illustrative process 600 for determining a plurality of search queries to gather evidence for answering a natural language question, according to embodiments. At 602, one or more candidate search queries are determined. In some embodiments, formulation of candidate search queries may employ one or more query generation templates 604, and may include applying question type 504, LAT 508, answer type 510, and/or query unit(s) 516 to the query generation template(s) 604. Query generation template(s) 604 may include templates that use one query unit (e.g., unigram units) and/or templates that use multiple query units (e.g., multigram units).

At 606, the one or more candidate queries are ranked to determine a predetermined number N (e.g., top 20) of the highest ranked candidate queries. In some embodiments, ranking of candidate queries employs a ranker that is trained offline using an unsupervised or supervised machine learning technique (e.g., SVM), the ranker ranking the candidate queries based on one or more features of the candidate queries. At 608, the top N ranked candidate queries are identified as the one or more search queries 610 to be executed by one or more search engines during the evidence gathering phrase.

### Example Operations for Evidence Gathering

FIG. 7 depicts a flow diagram of an illustrative process 700 for analyzing search results as evidence for answering a natural language question, according to embodiments. At 702, the one or more search queries 610 are provided for execution by one or more search engines, such as Microsoft® Bing®. At 704, search results are received from the one or more search engines, the search results resulting from a search performed based on each search query. In some embodiments, search results include an address or other identifier (e.g., URL, URI, IP address, and the like) for each result web page or web document, and/or a snippet of content from the result web page or document.

In some embodiments, the search results may have been ranked by the search engine according to relevance, and a top N (e.g. 20) number of search results may be selected from each set of search results for further processing. At 706, the top N search results from each set of search results are merged to form a merged set of search results for further processing. At 708, the merged search results are filtered to remove duplicate results and/or noise results. In some embodiments noise results may be determined based on a predetermined web site quality measurement (e.g., known low-quality sites may be filtered). In some embodiments, filtering may be further based on content readability or some other quality measurement of the content of the result web sites.

At 710, the search results are ranked using a ranker. In some embodiments, the ranker is trained offline using an unsupervised or supervised machine learning method (e.g., SVM), using a set of features. For example, for a natural language question Q, given the n candidate search result pages d₁ . . . dₙ, the ranking may include a binary classification based on search result pairs <dᵢ, dⱼ> where (1≦i, j≦n, i!=j). Linear ranking functions f_{\vec{w}}, may be defined based on features related to d and/or features describing a correspondence between Q and d. The weight vector \vec{w} may then be trained using a machine learning technique such as SVM. In this example, the search results list may then be ranked according to a score which is a dot-product of the feature function values and their corresponding weights for each result page.

In some embodiments, the features used for ranking may include, but are not limited to, one or more of the following:
The rank of the result page within the set of results generated from the search query, as ranked by the search engine;
The domain of snippet of the result, e.g. a quality of the domain;
A similarity between the result snippet and the natural language question;
A similarity between the title of the result page and the natural language question;
Whether there is a question point in the result snippet;
Whether there is a question point in the title of the result;
The query generation strategy, e.g. the particular query formulation template used to generate the query;
The length (e.g., number of words) in the query;
The number of search results returned by the search engine;
The number of the named entities in the result snippet;
The number of the named entities in the title of the result;
A type of the named entities in the result snippet; and/or
A type of the named entities in the title of the result.

At 712, the top N ranked search results are selected and identified as search results 714 for candidate answer extraction during the Answer Extraction and Ranking phase. In some embodiments, the top number of ranked search results is tunable (e.g., N may be tuned) based on a performance criterion.

### Example Operations for Answer Extraction and Ranking

FIG. 8 depicts a flow diagram of an illustrative process 800 for extracting possible answers from the search results 714, according to embodiments. At 802, one or more named entities may be extracted from search results 714. In some embodiments, the named entities are extracted based on their correspondence with the answer type and/or LAT as determined through a dictionary-based matching process. For example, if the natural language question has a predicted answer type of “person,” the “person” type named entities are extracted from the search results. At 804 the extracted named entities are normalized to expand contractions, correct spelling errors in the search results, expand proper names (e.g., Bill to William), and so forth.

At 806, one or more features are extracted for the candidate answers, and at 808, the candidate answers are ranked based on the features. In some embodiments, the ranking is performed using a ranker trained offline through a machine learning process such as SVM. In some embodiments, for a natural language question Q and given the n candidate answers h₁ . . . hₙ, the ranking may include a binary classification of candidate pairs <hᵢ, hⱼ> where (1≦i, j≦n, i!=j). Linear ranking functions f_{\vec{w}}; may be defined based on features related to the candidate answer h (e.g. the frequency of appearance of the candidate answer in search result pages) and/or features describing a correspondence between Q and h (e.g. LAT match). The weight vector (e.g., ranker) \vec{w} may be trained using a machine learning method such as SVM, and the answer candidate list may then be ranked according to each candidate's score which is a dot-product of feature function values and the corresponding weights.

The features used may include features that are common to all answer types, and/or features that are specific to particular answer types. In some embodiments, the common features include but are not limited to the following:
Frequency, e.g. the number of times the candidate answer appears in the search results;
Rank, e.g. the average rank of the candidate answer in the search results;
Query word match, e.g. a number of matched words between the queries and the search results containing the candidate answer;
LAT match, e.g. whether the candidate answer is a sub-class or an instance of the LAT. In some embodiments, this sub-class or instance-of relationship is determined through a linguistic database such as WordNet® or NeedleSeek®;
Is knowledge base article title, e.g. whether the candidate is extracted from a knowledge base (e.g., Wikipedia®) title in the search results;
Answer indexing, e.g. a number of matched points between the candidate's tagging (anchor text in a candidate's knowledge base article page) and the anchor text in all the knowledge base pages for terms that appear in the natural language question; and/or
LAT context, e.g. a number of matched words between those near the LAT in the natural language question (e.g., with a certain number of words, such as 5) and those near the answer candidate in the search words. In some embodiments, certain words (e.g. stop words) are ignored when determining context.

In some embodiments, the answer type-specific features include but are not limited to those in Table 1.

TABLE 1

| Answer Type | Features |
|---|---|
| Location | Inverted location answer indexing, e.g. whether |
| | the candidate is one of the tags of the location |
| | Candidate token length |
| | Location answer indexing, e.g. the number of |
| | the candidate's location tags that appear in the |
| | natural language question |
| Person | Gender score; in cases where the LAT could |
| | indicate a gender (e.g., king, queen, etc.), |
| | whether the candidate's gender matches the |
| | indicated gender. In some embodiments, |
| | gender information is determined from a |
| | knowledge base (e.g., Freebase ®) |
| | Single token, e.g. whether the candidate |
| | contains only one token or more than one token |
| Organization, | Token in question, e.g. whether the candidate |
| Person, or | has any token that also appears in the natural |
| Undetermined | language question |
| Type | |

At 810, a confidence level is determined for one or more of the candidate answers. In some embodiments, the confidence level is determined for the highest-ranked candidate answer. In some embodiments, the confidence level is determined for the top N ranked candidate answers or for all candidate answers. After the confidence level is determined, the answer may be provided to the user as described above with regard to FIG. 4. In some embodiments, confidence level calculation is performed using a regression SVM method, with features including but not limited to the following:
The number of LATs in the natural language question;
The number of queries generated by the natural language question;
The type for each of the search queries;
The answer type, e.g. the predicate answer type for the question;
The number of answer candidates generated for the natural language question;
Candidates score variance, e.g. the variance of the scores calculated for each candidate answer; and/or
The maximum score of all candidate answers.

### CONCLUSION

Although the techniques have been described in language specific to structural features and/or methodological acts, it is to be understood that the appended claims are not necessarily limited to the specific features or acts described. Rather, the specific features and acts are disclosed as example implementations of such techniques.

What is claimed is:

1. A computer-implemented method comprising:
analyzing a natural language question to predict a question type and an answer type for the natural language question;
formulating a ranked plurality of search queries based at least partly on the question type and on one or more query units extracted from the natural language question;
determining one or more candidate answers from a plurality of search results resulting from execution of at least some of the ranked plurality of search queries by a search engine, the determining based at least partly on the answer type;
ranking the one or more candidate answers according to a confidence level determined for each of the one or more candidate answers; and
providing a highest-ranked candidate answer of the one or more candidate answers based at least partly on a determination that the highest-ranked candidate answer has a confidence level higher than a predetermined threshold confidence.

2. The method of claim 1 wherein the question type is predicted through use of a classifier that is trained using a machine learning technique with multiple features.

3. The method of claim 2 wherein the machine learning technique is a support vector machine (SVM) technique.

4. The method of claim 1 wherein the answer type is predicted based at least partly on a plurality of predefined rules.

5. The method of claim 1 further comprising:
employing a ranker to rank the plurality of search queries, the ranker trained using a machine learning technique; and
determining a highest-ranked number of the plurality of search queries for execution by the search engine.

6. The method of claim 1 further comprising:
filtering the plurality of search results to remove at least one of a duplicate search result or a noise search result, prior to determining the one or more candidate answers.

7. The method of claim 1 wherein determining the one or more candidate answers includes:
extracting one or more named entities from the plurality of search results, the one or more named entities corresponding to the answer type, the extracting based at least partly on a dictionary matching of the one or more named entities with text of the plurality of search results; and
normalizing the one or more named entities to determine the one or more candidate answers.

8. The method of claim 1 wherein the one or more candidate answers are ranked through use of a ranker that is trained using a machine learning technique.

9. A system comprising:
at least one memory;
at least one processor in communication with the at least one memory; and
a natural language question processing component stored in the at least one memory and executed by the at least one processor to:
analyze a received natural language question to determine a question type and an answer type for the natural language question;
determine one or more query units from the natural language question;
formulate a plurality of search queries based at least partly on the question type and the one or more query units;
determine one or more candidate answers from a plurality of search results based at least partly on the answer type, the plurality of search results resulting from execution of at least some of the plurality of search queries by a search engine; and
rank the one or more candidate answers based at least partly on a confidence level determined for each of the one or more candidate answers.

10. The system of claim 9 wherein the question type is at least one of a factoid type, a definition type, a puzzle type, or a math type.

11. The system of claim 9 wherein the answer type is at least one of a person, a location, a date, a time, a quantity, an event, an organism, an object, or a concept.

12. The system of claim 9 wherein the natural language question processing component further operates to determine a lexical answer type for the natural language question based on the analysis of the natural language question, wherein the one or more candidate answers are determined further based at least partly on the lexical answer type.

13. The system of claim 12 wherein the lexical answer type is a subset of the answer type.

14. The system of claim 9 wherein 1 wherein determining the one or more query units is based at least partly on a grammar-based analysis of the natural language question.

15. The system of claim 9 wherein the one or more query units includes at least one of a word, a noun-phrase, a named entity, a quotation, a fact, a syntactic structure, or a paraphrase.

16. The system of claim 9 further comprising:
a machine learning component stored in the at least one memory and executed by the at least one processors to train a ranker using a machine learning technique;
wherein the natural language question processing component further operates to:
rank the plurality of search queries using the ranker; and
determine a highest-ranked number of the plurality of search queries for execution by the search engine.

17. One or more computer-readable storage media storing instructions that, when executed by at least one processor, instruct the at least one processor to perform actions comprising:
analyzing a received natural language question to determine a question type and an answer type for the natural language question;
formulating a plurality of search queries based at least partly on the question type and on one or more query units extracted from the natural language question;
extracting one or more candidate answers from a plurality of search results resulting from execution of at least some of the plurality of search queries; and
ranking the one or more candidate answers according to a confidence level determined for each of the one or more candidate answers.

18. The one or more computer-readable storage media of claim 17 wherein the actions further comprise:
providing a highest-ranked candidate answer based at least partly on a determination that the confidence level of the highest-ranked candidate answer is greater than a predetermined threshold confidence.

19. The one or more computer-readable storage media of claim 17 wherein each of the plurality of search results includes an address for a web site and a snippet of content from the web site.

20. The one or more computer-readable storage media of claim 17 wherein ranking the one or more candidate answers is based on a weight vector that is trained using a machine learning technique.
